(19) United States
(12) Patent Application Publication
(10) Pub. No.: US 2019/0072185 A1
(43) Pub. Date: Mar. 7, 2019

(54) LABYRINTH SEAL AND LABYRINTH SEAL STRUCTURE

(71) Applicant: Kabushiki Kaisha Kobe Seiko Sho (Kobe Steel, Ltd.), Hyogo (JP)

(72) Inventor: Shunsuke MORINAKA, Kobe-shi (JP)

(73) Assignee: Kabushiki Kaisha Kobe Seiko Sho (Kobe Steel, Ltd.), Hyogo (JP)

(21) Appl. No.: 16/110,889

(22) Filed: Aug. 23, 2018

(30) Foreign Application Priority Data
Sep. 7, 2017 (JP) 2017-172456
Apr. 9, 2018 (JP) 2018-074803

(51) Int. Cl. F16J 15/447

(52) U.S. Cl. CPC F16J 15/4472

(57) ABSTRACT

A labyrinth seal includes a step, a high-pressure-side landing, a low-pressure-side landing, a high-pressure-side fin, a low-pressure-side fin, and a protrusion. The protrusion extends from the high-pressure-side landing to an opposing-direction first side, and is arranged on a low pressure side with respect to the high-pressure-side fin. A connection portion (face) connecting from a face of the high-pressure-side fin on the low pressure side to a face of the low-pressure-side fin on the high pressure side out of a face of the first member on an opposing-direction second side is configured as a straight-line shape or an arc shape as viewed in a direction orthogonal respectively to an opposing direction and a flow direction.

### BACKGROUND OF THE INVENTION

### Field of the Invention

The present invention relates to a labyrinth seal and a labyrinth seal structure.

### Description of the Related Art

A conventional labyrinth seal is described, for example, in Japanese Patent Application Laid-Open No. 2012-72736 and the like. This labyrinth seal is used to suppress a leakage amount of fluid in a gap between two members (a rotating body and a stationary body, for example) constructing a fluid machine. With a technology illustrated in FIG. 4 of Japanese Patent Application Laid-Open No. 2012-72736, gaps between fins and a member are linearly arranged, and the fluid may linearly flow through. With a technology illustrated in FIG. 3 of Japanese Patent Application Laid-Open No. 2012-72736, steps are provided. Then, it is intended to suppress the leakage amount of the fluid by providing such a configuration that the fluid passing through gaps between fins and a member hits the fins.

However, it is desired to further suppress the leakage amount of the fluid.

### SUMMARY OF INVENTION

Therefore, it is an object of the present invention to provide a labyrinth seal and a labyrinth seal structure capable of suppressing the leakage amount of fluid.

A labyrinth seal according to the present invention is provided in a fluid machine. The fluid machine includes a first member, a second member opposing the first member, and a gap. The gap is formed between the first member and the second member. The gap is configured so that the fluid flows from a high pressure side to a low pressure side in a flow direction. The flow direction is a direction orthogonal to a direction in which the first member and the second member oppose each other. The direction in which the first member and the second member oppose each other is referred to as opposing direction. A side from the second member to the first member in the opposing direction is referred to as opposing-direction first side. A side from the first member to the second member in the opposing direction is referred to as opposing-direction second side. The labyrinth seal includes a step, a high-pressure-side landing, a low-pressure-side landing, a high-pressure-side fin, a low-pressure-side fin, and a protrusion. The step is formed on a portion of the second member on the opposing-direction first side. The high-pressure-side landing constructs a portion of the second member on the opposing-direction first side, and is arranged on the high pressure side with respect to the step. A low-pressure-side landing constructs a portion of the second member on the opposing-direction first side, is arranged on the low pressure side with respect to the step, and is arranged on the opposing-direction second side with respect to the high-pressure-side landing. The high-pressure-side fin extends from the first member toward the high-pressure-side landing, and is arranged on the high pressure side with respect to the step. The low-pressure-side fin extends from the first member toward the low-pressure-side landing, and is arranged on the low pressure side with respect to the step. The protrusion extends from the high-pressure-side landing to the opposing-direction first side, and is arranged on the low pressure side with respect to the high-pressure-side fin. A portion connecting from a face of the high-pressure-side fin on the low pressure side to a face of the low-pressure-side fin on the high pressure side is in a straight-line shape or an arc shape as viewed in a direction orthogonal respectively to the opposing direction and the flow direction out of a face of the first member on the opposing-direction second side.

With the above-mentioned configuration, the leakage amount of the fluid is suppressed at the labyrinth seal.

### BRIEF DESCRIPTION OF THE DRAWINGS

FIG. 1 is a cross sectional view of a part of a fluid machine including a labyrinth seal according to a first embodiment viewed in an orthogonal direction Z.

FIG. 2 is a view according to a second embodiment corresponding to FIG. 1.

FIG. 3 is a view according to a third embodiment corresponding to FIG. 1.

FIG. 4 is a view according to a fourth embodiment corresponding to FIG. 1.

FIG. 5 is a cross sectional view of a part of a fluid machine having a labyrinth seal structure according to a fifth embodiment viewed in the orthogonal direction Z.

FIG. 6 is a view according to a sixth embodiment corresponding to FIG. 1.

FIG. 7 is a view according to a seventh embodiment corresponding to FIG. 1.

FIG. 8 is a view according to an eighth embodiment corresponding to FIG. 1.

FIG. 9 is a view according to a ninth embodiment corresponding to FIG. 1.

FIG. 10 is a cross sectional view of a part of a fluid machine having a structure of a first example viewed in the orthogonal direction Z.

FIG. 11 is a cross sectional view of a part of a fluid machine having the labyrinth seal structure of a second example viewed in the orthogonal direction Z.

FIG. 12 is a chart of leakage amounts of the first example and the second example.

FIG. 13 is a diagram of h and c in the labyrinth seal shown in FIG. 1 corresponding to FIG. 1.

FIG. 14 is a chart of a relationship among h and c shown in FIG. 13 and the leakage amount.

### DESCRIPTION OF THE PREFERRED EMBODIMENTS

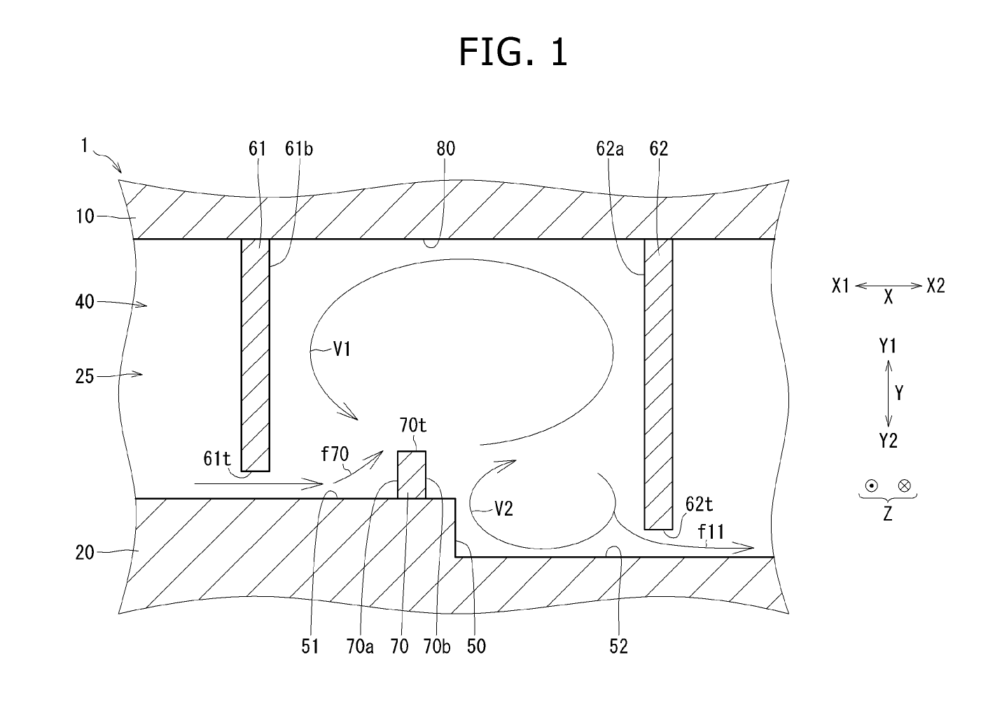

Referring to FIG. 1, a description will now be given of a fluid machine 1 provided with a labyrinth seal 40 according to a first embodiment.

The fluid machine 1 is a machine in which a second member 20 moves with respect to a first member 10. The fluid machine 1 is a machine that compresses/expands the fluid. The fluid machine 1 is a compressor, for example, and is a turbo compressor or the like, for example. The fluid machine 1 may be an expander, for example, or may be an expansion turbine or the like, for example. The fluid machine 1 is a rotary machine (fluid rotary machine) in which the second member 20 rotates with respect to the first member 10, for example. The fluid machine 1 may be of the axial-flow type or the centrifugal type. The fluid machine 1 includes the first member 10, the second member 20, a gap 25, and the labyrinth seal 40.

The first member 10 is a stationary body or a movable body. The second member 20 opposes the first member 10. If the first member 10 is a stationary body, the second member 20 is a movable body. If the first member 10 is a movable body, the second member 20 is a stationary body. The stationary body is a casing, for example. The stationary body may be a member arranged in the casing, and fixed to the casing, for example. The movable body is a rotating body rotating about an axis of rotation (not shown) with respect to the stationary body, for example. The rotating body may be an axis of rotation portion, for example, an impeller, for example, or an impeller with shroud, for example.

The gap 25 is formed between the first member 10 and the second member 20. The gap 25 is formed between a portion of the first member 10 on a Y2 side (opposing-direction second side) (details of directions are described later) and a portion of the second member 20 on a Y1-side (opposing-direction first side). The gap 25 is configured so that the fluid flows through the gap 25 from a high pressure side X1 in a flow direction X to a low pressure side X2 in the flow direction X. It should be noted that the fluid may flow in a direction other than the flow direction X (detailed later).

(Directions)

A direction in which the first member 10 and the second member 20 oppose each other is referred to as opposing direction Y. A side from the second member 20 to the first member 10 in the opposing direction Y is referred to as Y1 side (opposing-direction first side). A side from the first member 10 to the second member 20 in the opposing direction Y is referred to as Y2 side (opposing-direction second side). A direction orthogonal to the opposing direction Y is referred to as flow direction X. One side in the flow direction X is referred to as high pressure side X1. An opposite side of the high pressure side X1 in the flow direction X is referred to as low pressure side X2. If the fluid machine 1 is a rotary machine, a direction of the axis of rotation of the rotating body with respect to the stationary body may be any direction, may be the flow direction X, for example, may be the opposing direction Y, for example, or may be a direction inclined with respect to the flow direction X and the opposing direction Y, for example. A direction orthogonal respectively to the flow direction X and the opposing direction Y is referred to as orthogonal direction Z.

The labyrinth seal 40 (finned labyrinth seal) suppresses a leakage of the fluid at the gap 25. The labyrinth seal 40 suppresses the leakage, to thereby suppress a circulation of the fluid in the fluid machine 1 and the like, for example. The labyrinth seal 40 is a device for suppressing an amount of a leakage flow (hereinafter also referred to as leakage amount) without a contact (in a non-contact form) between the first member 10 and the second member 20. The labyrinth seal 40 includes a step 50, a high-pressure-side landing 51, a low-pressure-side landing 52, a high-pressure-side fin 61, a low-pressure-side fin 62, a protrusion 70, and a face 80.

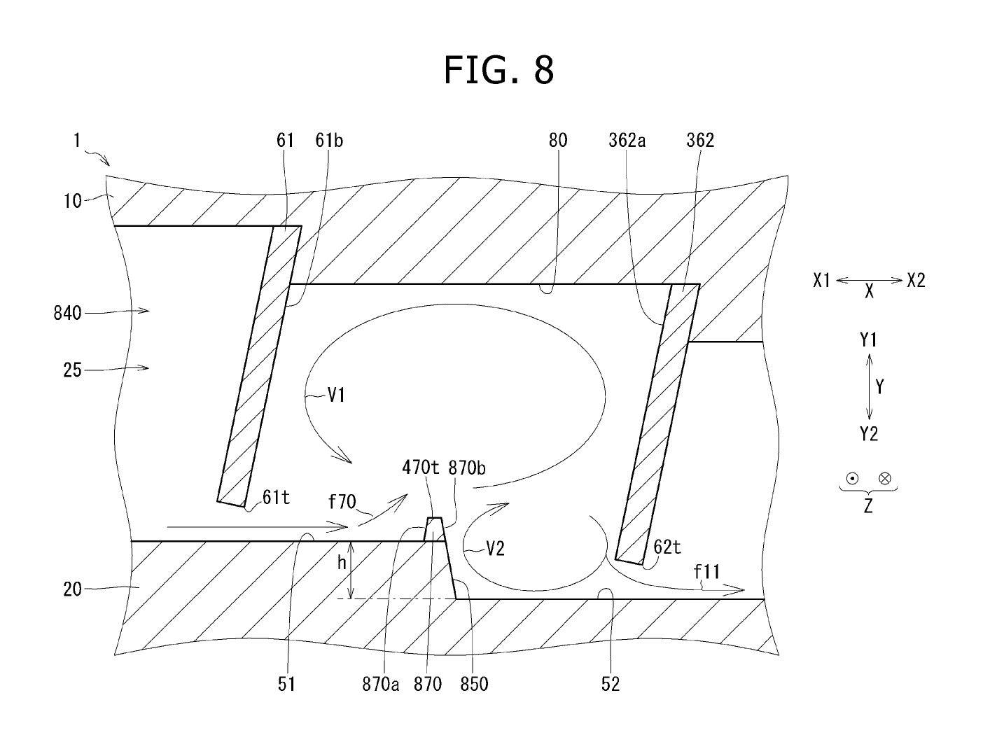

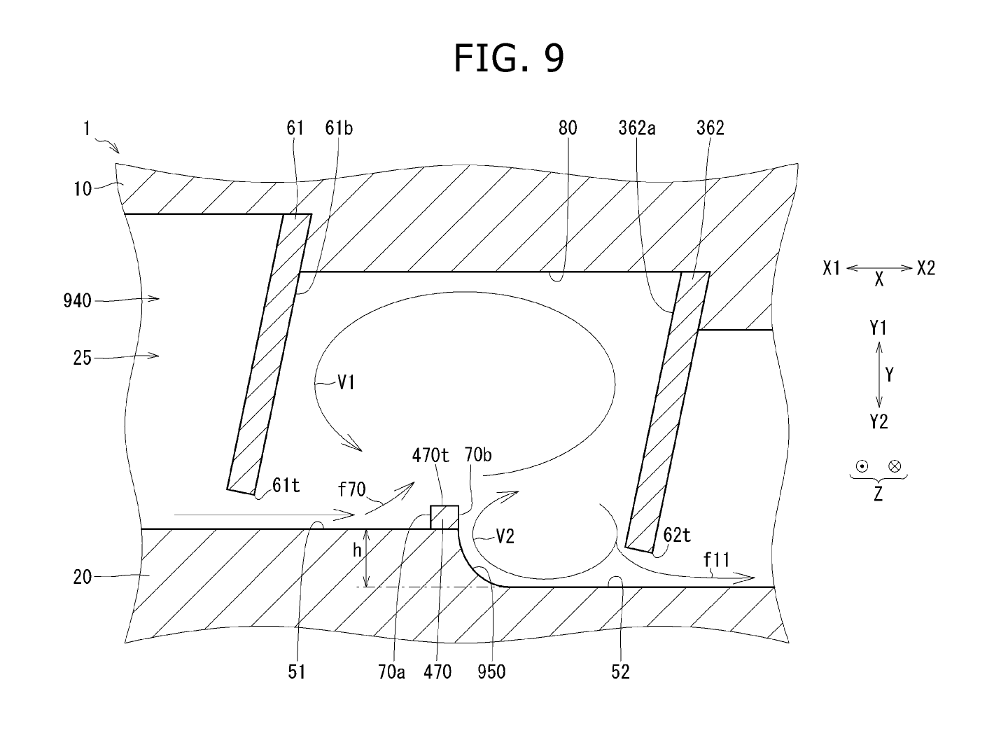

The step 50 is formed on a portion (a surface, for example) of the second member 20 on the Y1 side. The step 50 is a descending step structure in a sense. Specifically, the step 50 is configured so that the portion (low-pressure-side landing 52) of the second member 20 on the low pressure side X2 with respect to the step 50 is arranged on the Y2 side with respect to the portion (high-pressure-side landing 51) of the second member 20 on the high pressure side X1 with respect to the step 50. The step 50 is connected to an end of the high-pressure-side landing 51 on the low pressure side X2. The step 50 is connected to an end of the low-pressure-side landing 52 on the high pressure side X1. If the fluid machine 1 is a rotary machine, the step 50 is in an annular shape (ring shape) about the axis of rotation of the rotating body with respect to the stationary body. Such a point as the formation of the annular shape as described before applies respectively to the high-pressure-side fin 61, the low-pressure-side fin 62, and the protrusion 70. The step 50 may extend in the opposing direction Y, for example, may extend in a direction coincide with the opposing direction Y, for example, or may incline with respect to the opposing direction Y, for example (refer to FIG. 8 and FIG. 9). The step 50 may be in a straight-line shape, for example, a curve shape, for example (refer to FIG. 9), or a shape of a combination of a straight line and a curve, for example, as viewed in the orthogonal direction Z.

The high-pressure-side landing 51 forms a portion (a surface, for example) of the second member 20 on the Y1 side. The high-pressure-side landing 51 is arranged on the high pressure side X1 with respect to the step 50. The high-pressure-side landing 51 extends in the flow direction X, and extends in a direction coincident with the flow direction X, for example. The high-pressure-side landing 51 may be in a straight-line shape, for example, or may be in an approximately straight-line shape or the like, for example, as viewed in the orthogonal direction Z.

The low-pressure-side landing 52 forms a portion (a surface, for example) of the second member 20 on the Y1 side. The low-pressure-side landing 52 is arranged on the low pressure side X2 with respect to the step 50. The low-pressure-side landing 52 is arranged on the Y2 side with respect to the high-pressure-side landing 51. A shape of the low-pressure-side landing 52 is similar to a shape of the high-pressure-side landing 51, for example, and may be different from the shape of the high-pressure-side landing 51, for example. For example, if the fluid machine 1 is a rotary machine, and the axis of rotation of the rotating body with respect to the stationary body coincides with the flow direction X, the high-pressure-side landing 51 and the low-pressure-side landing 52 are respectively in cylindrical shapes about the axis of rotation. If the Y1 side is a radially outer side (the Y2 side is a radially inner side) in this case, the high-pressure-side landing 51 is larger in diameter than the low-pressure-side landing 52.

The high-pressure-side fin 61 is a fin for partitioning the gap 25 (the same applies to the low-pressure-side fin 62). The high-pressure-side fin 61 does not completely partition the gap 25, and is arranged so as to narrow a flow passageway of the fluid (the same applies to the low-pressure-side fin 62). The high-pressure-side fin 61 extends (is prolonged) from a portion (a surface, for example) of the first member 10 on the Y2 side toward the high-pressure-side landing 51 (to the Y2 side). The high-pressure-side fin 61 is arranged on the high pressure side X1 with respect to the step 50. The high-pressure-side fin 61 extends from a portion of the first member 10 on the high pressure side X1 with respect to the step 50 toward the high-pressure-side landing 51. The high-pressure-side fin 61 may be provided integrally with the second member 20, for example, or may be independent of the first member 10, for example (the same applies to the low-pressure-side fin 62). The high-pressure-side fin 61 includes a high-pressure-side-fin side face 61b and a high-pressure-side-fin distal end 61t.

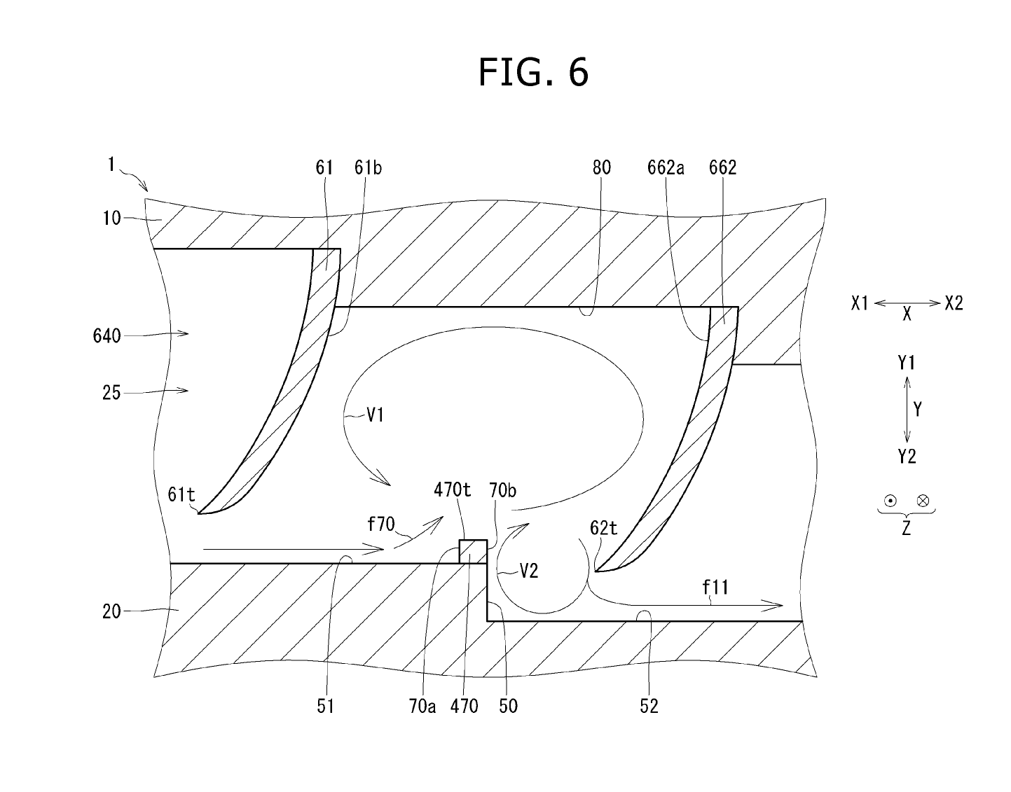

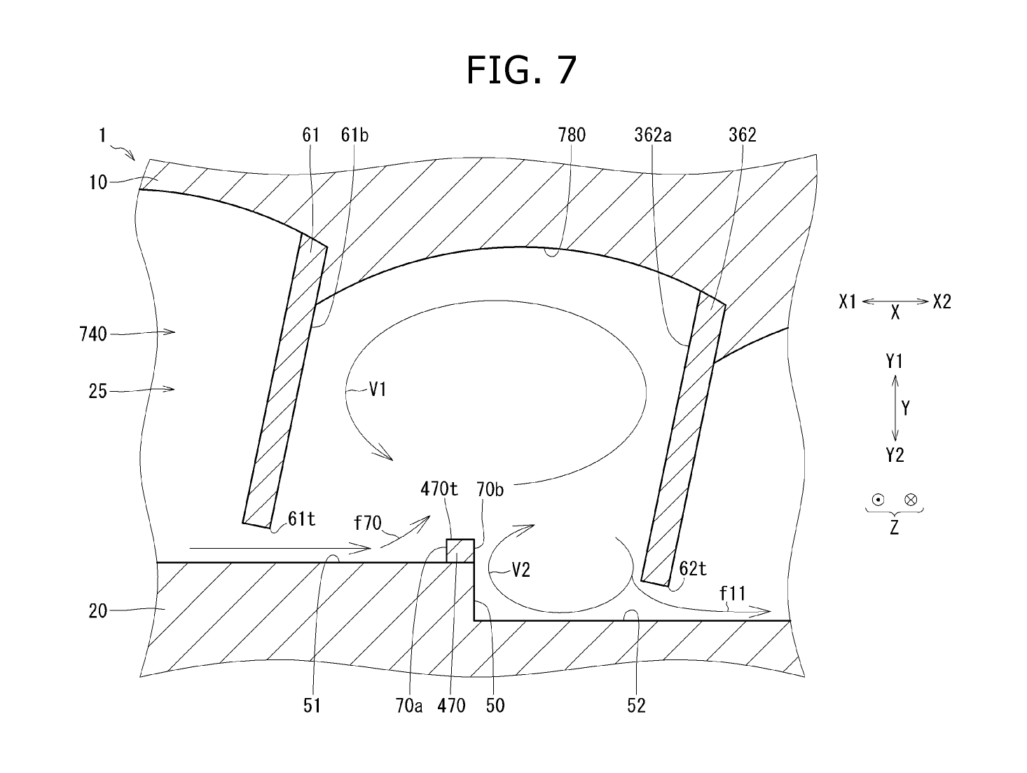

The high-pressure-side-fin side face 61b is a face (surface) constructing the high-pressure-side fin 61, and is a face facing the low pressure side X2. The high-pressure-side-fin side face 61b may extend in a direction coincident with the opposing direction Y, for example, or may incline with respect to the opposing direction Y (refer to FIG. 7 and the like) (the same applies respectively to side faces of the low-pressure-side fin 62 and the protrusion 70). The high-pressure-side-fin side face 61b may be in a straight-line shape, for example, a curve shape, for example (refer to FIG. 6), or a shape of a combination of a straight line and a curve, for example, as viewed in the orthogonal direction Z (the same applies to respective side faces of the low-pressure-side fin 62 and the protrusion 70).

The high-pressure-side-fin distal end 61t is a distal end of the high-pressure-side fin 61, and is an end of the high-pressure-side fin 61 on a high-pressure-side landing 51 side (Y2 side). The high-pressure-side-fin distal end 61t is arranged on the high-pressure-side landing 51 side (Y2 side) with respect to a center in the opposing direction Y between the first member 10 and the high-pressure-side landing 51, for example, and is arranged in a neighborhood of the high-pressure-side landing 51, for example.

The low-pressure-side fin 62 extends from a portion (a surface, for example) of the first member 10 on the Y2 side toward the low-pressure-side landing 52 (to the Y2 side). The low-pressure-side fin 62 is arranged on the low pressure side X2 with respect to the step 50. The low-pressure-side fin 62 extends from a portion of the first member 10 on the low pressure side X2 with respect to the step 50 toward the low-pressure-side landing 52. The low-pressure-side fin 62 extends to the Y2 side with respect to the high-pressure-side landing 51. The low-pressure-side fin 62 includes a low-pressure-side-fin side face 62a and a low-pressure-side-fin distal end 62t.

The low-pressure-side-fin side face 62a is a face (surface) constructing the low-pressure-side fin 62, and is a face facing the high pressure side X1. The low-pressure-side-fin distal end 62t is a distal end of the low-pressure-side fin 62, and is an end of the low-pressure-side fin 62 on a low-pressure-side landing 52 side (Y2 side). The low-pressure-side-fin distal end 62t is arranged on the low-pressure-side landing 52 side (Y2 side) with respect to a center in the opposing direction Y between the first member 10 and the low-pressure-side landing 52, for example, and is arranged in a neighborhood of the low-pressure-side landing 52, for example. The low-pressure-side-fin distal end 62t is arranged on the Y2 side with respect to a protrusion distal end 70t (described later). The low-pressure-side-fin distal end 62t is arranged on the Y2 side with respect to the high-pressure-side landing 51.

The protrusion 70 extends (protrudes) from the high-pressure-side landing 51 to the Y1 side. The protrusion 70 is arranged on the high pressure side X1 with respect to the step 50. The protrusion 70 is arranged on the low pressure side X2 with respect to the high-pressure-side fin 61. The protrusion 70 extends from a portion of the high-pressure-side landing 51 on the low pressure side X2 with respect to the high-pressure-side fin 61 to the Y1 side. The protrusion 70 includes a protrusion-high-pressure-side side face 70a, a protrusion-low-pressure-side side face 70b, and the protrusion distal end 70t.

The protrusion-high-pressure-side side face 70a is a face (surface) constructing the protrusion 70, and is a face facing the high pressure side X1. The protrusion-high-pressure-side side face 70a is arranged on the low pressure side X2 with respect to the high-pressure-side-fin side face 61b, and is arranged so as to be separated from the high-pressure-side-fin side face 61b in the flow direction X.

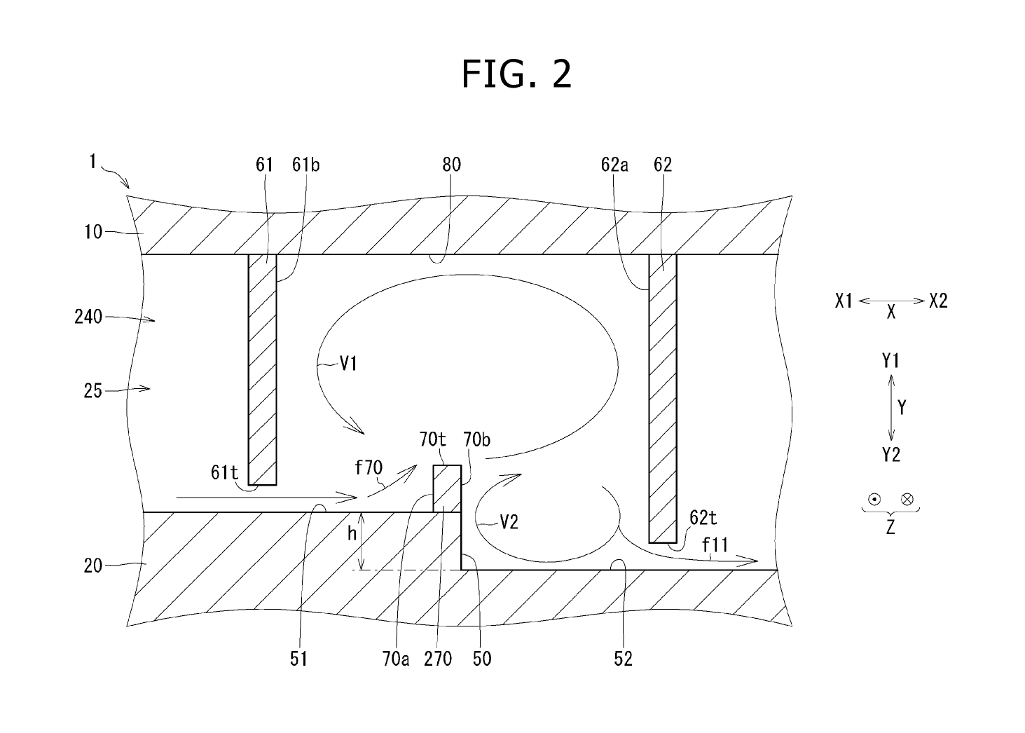

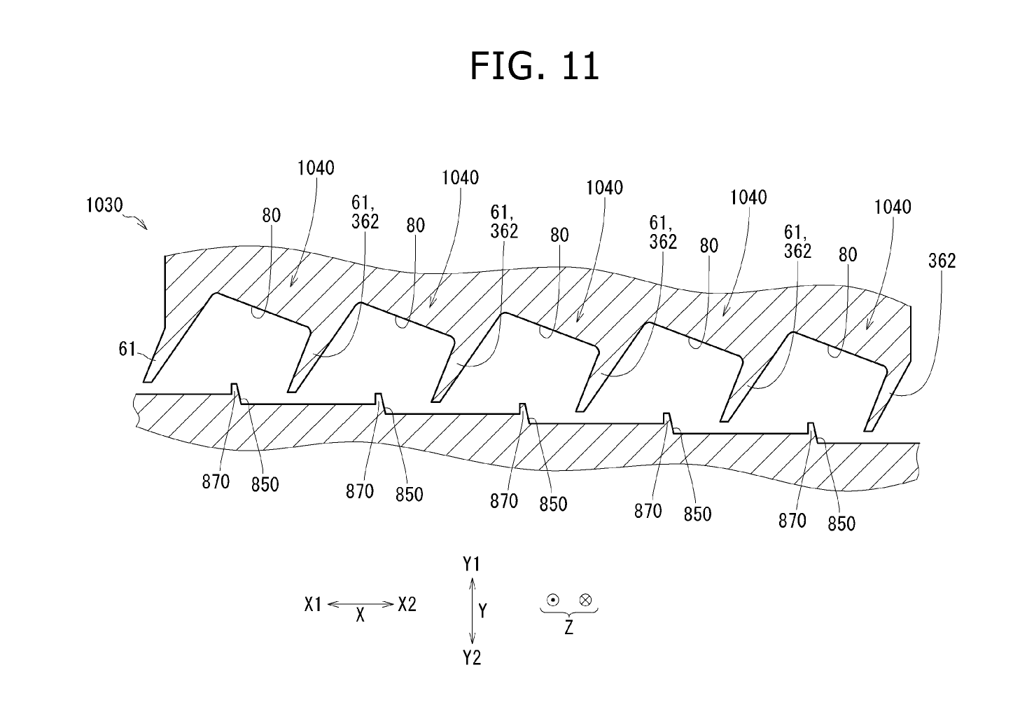

The protrusion-low-pressure-side side face 70b is a face (surface) constructing the protrusion 70, and is a face facing the low pressure side X2. A flow-direction-X position (a position in the flow direction X) of the protrusion-low-pressure-side side face 70b is a position on the high pressure side X1 with respect to a flow-direction-X position of the step 50, for example, and may be the same position as the flow-direction-X position of the step 50, for example (refer to FIG. 2). A width (thickness) of the protrusion 70 in the flow direction X, namely, a distance from the protrusion-high-pressure-side side face 70a to the protrusion-low-pressure-side side face 70b in the flow direction X may be the same as a thickness of the high-pressure-side fin 61, for example, or may be the same as a thickness of a low-pressure-side fin 62, for example. It should be noted that the thickness of the high-pressure-side fin 61 may be the same as or different from the thickness of the low-pressure-side fin 62. The thickness of the protrusion 70 may be constant or not constant from a base portion to the distal end. For example, the thickness of the protrusion 70 may decrease toward the distal end side (Y1 side) (refer to FIG. 8) (the same applies to a thickness of the high-pressure-side fin 61 and a thickness of the low-pressure-side fin 62 (refer to FIG. 11))

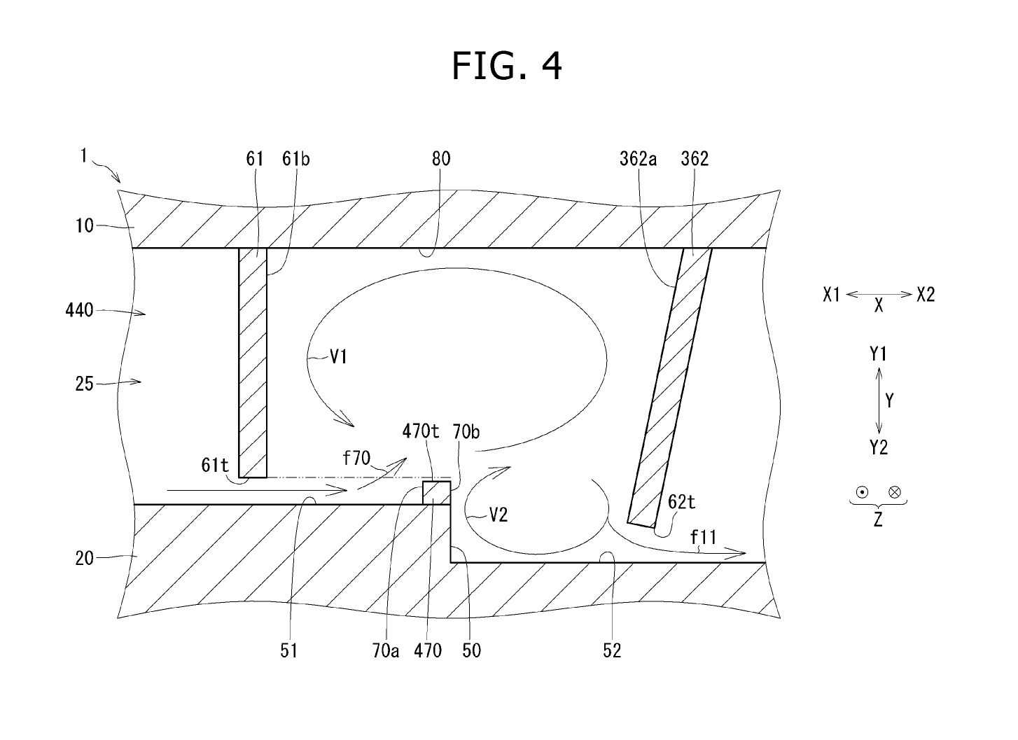

The protrusion distal end 70t is a distal end of the protrusion 70, and is an end of the protrusion 70 on a first member 10 side (Y1 side). The protrusion distal end 70t is arranged on the high-pressure-side landing 51 side (Y2 side) with respect to the center in the opposing direction Y between the first member 10 and the high-pressure-side landing 51, for example. An opposing-direction Y position (a position in the opposing direction Y) of the protrusion distal end 70t may be a position on the first member 10 side (Y1 side) with respect to the high-pressure-side-fin distal end 61t, or a position the same as an opposing-direction Y position of the high-pressure-side-fin distal end 61t, for example. The opposing-direction Y position of the protrusion distal end 70t may be on the high-pressure-side landing 51 side (Y2 side) with respect to the opposing-direction Y position of the high-pressure-side-fin distal end 61t (refer to FIG. 4).

The face 80 is a portion connecting from the face of the high-pressure-side fin 61 on the low pressure side X2 (high-pressure-side-fin side face 61b) to the face of the low-pressure-side fin 62 on the high pressure side X1 (low-pressure-side-fin side face 62a) out of a face (surface) of the first member 10 on the Y2 side. The face 80 is in a straight-line shape or an arc shape as viewed in the orthogonal direction Z (refer to FIG. 7, and the “arc shape” is described later). The “straight-line shape” includes an approximately straight-line shape. The face 80 smoothly connects from the high-pressure-side-fin side face 61b to the low-pressure-side-fin side face 62a. The face 80 does not include a curved (bent) portion, and does not have a step such as the step 50, for example. The face 80 may extend in a direction coincident with the flow direction X, for example, may extend in a direction approximately coincide with the flow direction X, for example, or may incline with respect to the flow direction X, for example (refer to FIG. 7 and FIG. 11).

(Flow of Fluid)

The fluid flowing through the gap 25 flows as follows, for example. The fluid on the high pressure side X1 with respect to the high-pressure-side fin 61 flows to the low pressure side X2, passes through a gap between the high-pressure-side-fin distal end 61t and the high-pressure-side landing 51, flows along the high-pressure-side landing 51, and hits the protrusion-high-pressure-side side face 70a. Thus, the fluid flowing along the high-pressure-side landing 51 to the low pressure side X2 flows also to the Y1 side while flowing to the low pressure side X2 in a neighborhood of the protrusion 70. The flow flowing to both the low pressure side X2 and the Y1 side in a direction inclining with respect to the flow direction X in the neighborhood of the protrusion 70 in this way is referred to as flow f70. The flow f70 joins a vortex V1. This fluid flows from a neighborhood of the protrusion distal end 70t to the low pressure side X2, hits the low-pressure-side-fin side face 62a, and branches into the vortex V1 and a vortex V2 in a neighborhood of the low-pressure-side-fin side face 62a.

The vortex V1 flows as follows. The fluid which has flown to the X2 side toward the low-pressure-side-fin side face 62a, and has hit the low-pressure-side-fin side face 62a changes its direction to the Y1 side, hits the face 80, changes its direction to the high pressure side X1, hits the high-pressure-side-fin side face 61b, and changes its direction to the Y2 side. This fluid approaches the flow to the low pressure side X2 in a neighborhood of the high-pressure-side landing 51, and changes its direction to the low pressure side X2. This fluid passes the neighborhood of the protrusion distal end 70t, and flows to the low pressure side X2.

The vortex V2 flows as follows. The fluid which has flown to the X2 side toward the low-pressure-side-fin side face 62a, and has hit the low-pressure-side-fin side face 62a changes its direction to the Y2 side, and hits the low-pressure-side landing 52. This fluid changes its direction to the high pressure side X1, hits the step 50, and changes its direction to the Y1 side. This fluid approaches the flow from the protrusion distal end 70t to the low pressure side X2, and changes its direction to the low pressure side X2.

A leakage flow f11 branches from the vortex V2 as follows. The fluid which has flown to the X2 side toward the low-pressure-side-fin side face 62a, and has hit the low-pressure-side-fin side face 62a changes its direction to the Y2 side, and hits the low-pressure-side landing 52. A part of the fluid changes its direction to the low pressure side X2, and forms the leakage flow f11. The leakage flow f11 passes through a gap between the low-pressure-side-fin distal end 62t and the low-pressure-side landing 52, and flows (leaks) to the low pressure side X2 with respect to the low-pressure-side fin 62.

The vortex V1 and the vortex V2 generate fluid friction, resulting in generation of a fluid energy loss. The “fluid friction” includes not only a friction between flows of fluid, but also a friction between an object considered as fluid having a flow rate of zero and fluid. The “objects considered as fluid having a flow rate of zero” include the step 50, the high-pressure-side landing 51, the low-pressure-side landing 52, the high-pressure-side fin 61, the low-pressure-side fin 62, and the face 80.

Effects of the labyrinth seal 40 shown in FIG. 1 are as follows.

(First Effect of the Present Invention)

[Configuration 1-1] The labyrinth seal 40 is provided in the fluid machine 1. The fluid machine 1 includes the first member 10, the second member 20 opposing the first member 10, and the gap 25. The gap 25 is formed between the first member 10 and the second member 20. The gap 25 is configured so that the fluid flows from the high pressure side X1 to the low pressure side X2 in the flow direction X. The flow direction X is the direction orthogonal to the direction (opposing direction Y) in which the first member 10 and the second member 20 oppose each other. The direction in which the first member 10 and the second member 20 oppose each other is referred to as opposing direction Y. The side from the second member 20 to the first member 10 in the opposing direction Y is referred to as Y1 side (opposing-direction first side). The side from the first member 10 to the second member 20 in the opposing direction Y is referred to as Y2 side (opposing-direction second side). The labyrinth seal 40 includes the step 50, the high-pressure-side landing 51, the low-pressure-side landing 52, the high-pressure-side fin 61, the low-pressure-side fin 62, and the protrusion 70. The step 50 is formed on the portion of the second member 20 on the Y1 side. The high-pressure-side landing 51 forms the portion of the second member 20 on the Y1 side, and is arranged on the high pressure side X1 with respect to the step 50. The low-pressure-side landing 52 forms the portion of the second member 20 on the Y1 side, is arranged on the low pressure side X2 with respect to the step 50, and is arranged on the Y2 side with respect to the high-pressure-side landing 51. The high-pressure-side fin 61 extends from the first member 10 toward the high-pressure-side landing 51, and is arranged on the high pressure side X1 with respect to the step 50. The low-pressure-side fin 62 extends from the first member 10 toward the low-pressure-side landing 52, and is arranged on the low pressure side X2 with respect to the step 50.

[Configuration 1-2] The protrusion 70 extends from the high-pressure-side landing 51 to the Y1 side, and is arranged on the low pressure side X2 with respect to the high-pressure-side fin 61.

[Configuration 1-3] The portion (face 80) connecting from the face of the high-pressure-side fin 61 on the low pressure side X2 (high-pressure-side-fin side face 61b) to the face of the low-pressure-side fin 62 on the high pressure side X1 (low-pressure-side-fin side face 62a) out of the face of the first member 10 on the Y2 side is configured as follows. The face 80 is in a straight-line shape or an arc shape viewed in the direction (orthogonal direction Z) orthogonal respectively to the opposing direction Y and the flow direction X.

The vortex V1 is likely formed in the space between the high-pressure-side fin 61 and the low-pressure-side fin 62, and on the Y1 side with respect to the high-pressure-side landing 51 in [Configuration 1-1]. Moreover, the vortex V2 is likely formed in the space between the step 50 and the low-pressure-side fin 62, and on the Y2 side with respect to the high-pressure-side landing 51. On this occasion, the fluid flowing along the high-pressure-side landing 51 to the low pressure side X2 hits the protrusion 70 with [Configuration 1-2]. Then, this fluid flows to the Y1 side (forms the flow f70) while flowing to the low pressure side X2. Thus, the fluid flowing from the neighborhood of the protrusion distal end 70t to the low pressure side X2 flows more likely to the Y1 side than to the Y2 side, and thus likely forms the vortex V1. Thus, the flow amount and the flow rate of the vortex V1 can be increased compared with a case without the protrusion 70. Thus, the fluid friction by the vortex V1 can be increased, and the fluid energy loss (friction loss) can be increased. Thus, the leakage amount of the fluid is suppressed at the labyrinth seal 40.

Moreover, a size of the vortex V2 can be increased with [Configuration 1-2]. In more detail, if the protrusion 70 is not provided, a Y position in the opposing direction of a Y1-side end of the vortex V2 is approximately the same as a Y position of the high-pressure-side landing 51 in the opposing direction, for example. On the other hand, a Y position in the opposing direction of the Y1-side end of the vortex V2 is likely on the Y1 side with respect to the Y position in the opposing direction of the high-pressure-side landing 51, and is a position approximately the same as a Y position in the opposing direction of the protrusion distal end 70t, for example, in this embodiment. The size of the vortex V2 can be increased in this way, the fluid friction by the vortex V2 can thus be increased, and the fluid energy loss (friction loss) can be increased. Thus, the leakage amount of the fluid is suppressed at the labyrinth seal 40.

Moreover, the vortex V1 likely flows along the face 80 with [Configuration 1-3] compared with a case in which a step or the like exists on the face 80, for example. Thus, the fluid friction by the vortex V1 can be increased, and the fluid energy loss (friction loss) can be increased. Thus, the leakage amount of the fluid is suppressed at the labyrinth seal 40.

(Fourth Effect of the Present Invention)

[Configuration 4] The second member 20 can rotate about the axis of rotation extending in the flow direction X with respect to the first member 10.

The labyrinth seal 40 can be applied to the fluid machine 1 having the structure of [Configuration 4].

(Sixth Effect of the Present Invention)

[Configuration 6] The second member 20 can rotate about an axis of rotation extending in a direction (the opposing direction Y, for example) orthogonal to the flow direction X with respect to the first member 10.

The labyrinth seal 40 can be applied to the fluid machine 1 having the structure of [Configuration 6].

### Second Embodiment

A description will now be given of a different point of a labyrinth seal 240 according to a second embodiment from the first embodiment (refer to FIG. 1) with reference to FIG. 2. It should be noted that, out of the labyrinth seal 240 according to the second embodiment, like points are denoted by like numerals as of the first embodiment, and a description thereof is omitted (the omission of the description of the common points applies to descriptions of other embodiments). The different point includes the position of a protrusion 270.

The protrusion 270 is provided on a portion of the high-pressure-side landing 51 closest to the low pressure side X2. A flow-direction X position of the protrusion-low-pressure-side side face 70b is the same as a flow-direction X position of the step 50. The protrusion-low-pressure-side side face 70b is arranged so as to continue to (flush with) the step 50. The protrusion-high-pressure-side side face 70a shown in FIG. 2 is arranged on the low pressure side X2 compared with the example shown in FIG. 1.

(Flow of Fluid)

A different point of the flow of the fluid according to this embodiment from the flow of the fluid according to the first embodiment (refer to FIG. 1) is as follows. The fluid flowing along the high-pressure-side landing 51 to the low pressure side X2 hits the protrusion-high-pressure-side side face 70a of the protrusion 270 at the position displaced more to the low pressure side X2 than the first embodiment. Thus, the flow f70 can be joined to the vortex V1 at a position displaced more to the low pressure side X2 (position that promotes closer alignment to the flow of the vortex V1). Thus, the flow amount and the flow rate of the vortex V1 can be increased.

The vortex V2 flows along the low-pressure-side landing 52 to the high pressure side X1, hits the step 50, and flows along the step 50 and the protrusion-low-pressure-side side face 70b to the Y1 side. Thus, the flow amount and the flow rate of the vortex V2 can be increased compared with the case in which the vortex V2 does not flow along the protrusion-low-pressure-side side face 70b (refer to FIG. 1).

Effects of the labyrinth seal 240 shown in FIG. 2 are as follows.

(Second Effect of the Present Invention)

[Configuration 2] The protrusion 270 is provided at the portion of the high-pressure-side landing 51 closest to the low pressure side X2.

With [Configuration 2], the flow of the vortex V2 likely flows along the step 50 and the protrusion-high-pressure-side side face 70a of the protrusion 270. Thus, the flow amount and the flow rate of the vortex V2 can be increased. Thus, the fluid friction by the vortex V2 can be increased, and the fluid energy loss can be increased. Thus, the leakage amount of the fluid is suppressed more at the labyrinth seal 240.

The following effect may be provided with [Configuration 2]. The arrangement of the protrusion-high-pressure-side side face 70a of the protrusion 270 more to the low pressure side X2 is promoted with [Configuration 2]. Thus, the flow f70 can be joined to the vortex V1 at a position displaced more to the low pressure side X2 (position that promotes closer alignment to the flow of the vortex V1). Thus, the flow amount and the flow rate of the vortex V1 can be increased more, the fluid friction by the vortex V1 can be increased more, and the fluid energy loss can be increased more. Thus, the leakage amount of the fluid is suppressed more at the labyrinth seal 240.

### Third Embodiment

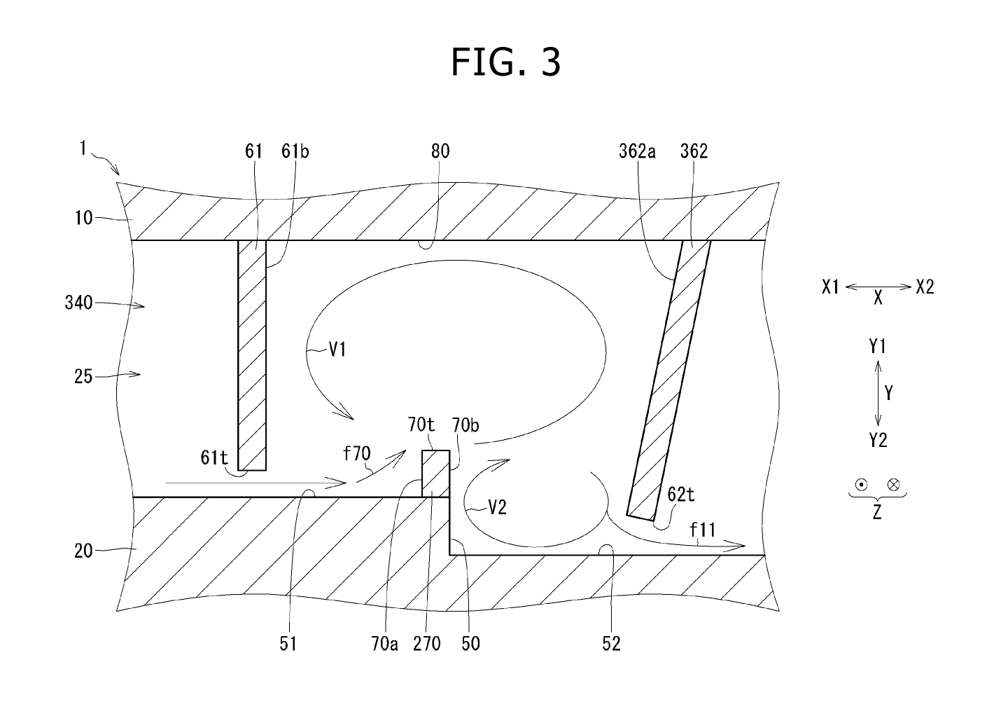

A description will now be given of a different point of a labyrinth seal 340 according to a third embodiment from the second embodiment (refer to FIG. 2) with reference to FIG. 3. The different point includes the arrangement of a low-pressure-side fin 362.

In the low-pressure-side fin 362, the low-pressure-side-fin distal end 62t is arranged on the high pressure side X1 with respect to an end (a base portion or a root portion) on the Y1 side of the low-pressure-side fin 362. A Y2-side end of the low-pressure-side-fin side face 362a of the low-pressure-side fin 362 is arranged on the high pressure side X1 with respect to a Y1-side end of the low-pressure-side-fin side face 362a. For example, the low-pressure-side-fin side face 362a inclines with respect to the opposing direction Y so as to be arranged closer to the high pressure side X1 toward the Y2 side. A portion which the fluid flowing from the neighborhood of the protrusion distal end 70t to the low pressure side X2 hits out of the low-pressure-side-fin side face 362a inclines with respect to the opposing direction Y as described before. For example, an entirety of the low-pressure-side-fin side face 362a may incline with respect to the opposing direction Y as described before.

(Flow of Fluid)

A different point of the flow of the fluid according to this embodiment from the flow of the fluid according to the second embodiment (refer to FIG. 2) is as follows. The fluid flowing from the neighborhood of the protrusion distal end 70t to the low pressure side X2 hits the low-pressure-side-fin side face 362a. On this occasion, the low-pressure-side-fin distal end 62t of the low-pressure-side fin 362 is arranged on the high pressure side X1 with respect to the Y2-side end of the low-pressure-side fin 362, and the fluid thus likely flows to the Y1 side more than to the Y2 side. Moreover, the low-pressure-side-fin side face 362a inclines with respect to the opposing direction Y so as to be arranged closer to the high pressure side X1 toward the Y2 side, and the fluid thus likely flows to the Y1 side more than to the Y2 side. Thus, the flow amount and the flow rate of the vortex V1 can be increased. Moreover, a flow amount branching from the vortex V1 to the vortex V2 can be decreased, and a flow amount branching from the vortex V2 to the leakage flow f11 can thus be decreased.

Effects of the labyrinth seal 340 shown in FIG. 3 are as follows.

(Third Effect of the Present Invention)

[Configuration 3] The end (low-pressure-side-fin distal end 62t) on the Y2 side of the low-pressure-side fin 362 is arranged on the high pressure side X1 with respect to the end of the low-pressure-side fin 362 on the Y1 side.

With [Configuration 3], the fluid flowing to the low pressure side X2 toward the low-pressure-side fin 362 likely flows to the Y1 side. Thus, the flow amount and the flow rate of the vortex V1 can be increased more, the fluid friction by the vortex V1 can be increased more, and the fluid energy loss can be increased more. Thus, the leakage amount of the fluid is suppressed more at the labyrinth seal 340. Moreover, the fluid flowing to the low pressure side X2 toward the low-pressure-side fin 362 less likely flows to the Y2 side. Thus, the fluid less likely leaks from the gap between the low-pressure-side-fin distal end 62t and the low-pressure-side landing 52. Thus, the leakage amount of the fluid is suppressed more at the labyrinth seal 340.

### Fourth Embodiment

A description will now be given of a different point of a labyrinth seal 440 according to a fourth embodiment from the third embodiment (refer to FIG. 3) with reference to FIG. 4. The different point includes a height of a protrusion 470 from the high-pressure-side landing 51 and the like.

The fluid machine 1 is a rotary machine. One of the first member 10 and the second member 20 is a stationary body, and the other one is a rotating body. The second member 20 can (relatively) rotate about the axis of rotation extending in the flow direction X with respect to the first member 10. Each of the step 50, the high-pressure-side fin 61, the low-pressure-side fin 362, and the protrusion 470 is an annular shape about the axis of rotation extending in the flow direction X. Each of the high-pressure-side landing 51 and the low-pressure-side landing 52 is in a cylindrical shape about the axis of rotation extending in the flow direction X.

For example, the first member 10 is a member (stationary body) in a cylindrical shape, and the second member 20 is a small-diameter member (rotating body such as a cylinder) smaller in diameter than the first member 10. Moreover, for example, the second member 20 may be a member (stationary body) in a cylindrical shape, and the first member 10 is a small-diameter member (rotating body such as a cylinder) smaller in diameter than the second member 20.

A protrusion distal end 470t of the protrusion 470 is arranged on the Y2 side with respect to the high-pressure-side-fin distal end 61t. The length in the opposing direction Y (height from the high-pressure-side landing 51) of the protrusion 470 is shorter than the gap (clearance) in the opposing direction Y between the high-pressure-side-fin distal end 61t and the high-pressure-side landing 51.

(Assembly)

Assembly (attachment) between the first member 10 and the second member 20 is carried out as follows. Both a state in which the high-pressure-side fin 61 and the low-pressure-side fin 362 are provided on the first member 10 and a state in which the step 50 and the protrusion 470 are provided on the second member 20 are brought about. Then, the second member 20 is moved (relatively moved) in the flow direction X (direction of the rotation axis) with respect to the first member 10. On this occasion, the small-diameter member (the second member 20, for example) is inserted into the cylindrical member (the first member 10, for example). In other words, the cylindrical member is fed over a radially outer side of the small-diameter member. Then, the protrusion 470 moves at a position on the Y2 side with respect to the high-pressure-side fin 61 (at a radially inner or radially outer position) from the high pressure side X1 with respect to the high-pressure-side fin 61 to the low pressure side X2 with respect to the high-pressure-side fin 61. Then, the protrusion 470 is arranged at a predetermined position in the flow direction X between the high-pressure-side fin 61 and the low-pressure-side fin 362. The first member 10 does not need to be divided, and the second member 20 does not need to be divided in this assembly. Thus, the first member 10 and the second member 20 can easily be assembled to each other.

It should be noted that the assembly cannot be carried out in such a case that the protrusion distal end 70t is arranged on the Y1 side with respect to the high-pressure-side-fin distal end 61t shown in FIG. 1 and the like. In this case, at least either one of the first member 10 and the second member 20 is divided into multiple parts. Then, the divided parts are coupled (fixed) to one another after the first member 10 and the second member 20 are combined with (fitted to) each other.

Effects of the labyrinth seal 440 shown in FIG. 4 are as follows.

(Fifth Effect of the Present Invention)

[Configuration 5] The labyrinth seal 440 has [Configuration 4]. The Y1-side end of the protrusion 470 (protrusion distal end 470t) is arranged on the Y2 side with respect to the end of the high-pressure-side fin 61 (high-pressure-side-fin distal end 61t) on the Y2 side.

The labyrinth seal 440 has [Configuration 5]. Thus, when the second member 20 is moved in the flow direction X (direction of the rotation axis) with respect to the first member 10, the protrusion 470 can be moved at the position on the Y2 side with respect to the high-pressure-side fin 61 from the high pressure side X1 with respect to the high-pressure-side fin 61 to the low pressure side X2 with respect to the high-pressure-side fin 61. Thus, when the first member 10 and the second member 20 are assembled to each other, the first member 10 does not need to be divided, and the second member 20 does not need to be divided. Thus, the first member 10 and the second member 20 can easily be assembled to each other. On this occasion, if the protrusion 470 is not provided, though the first member 10 and the second member 20 can easily be assembled to each other, the leakage amount of the fluid may increase. On the other hand, the leakage amount of the fluid can be suppressed by the protrusion 470, and the first member 10 and the second member 20 can easily be assembled to each other in this embodiment.

### Fifth Embodiment

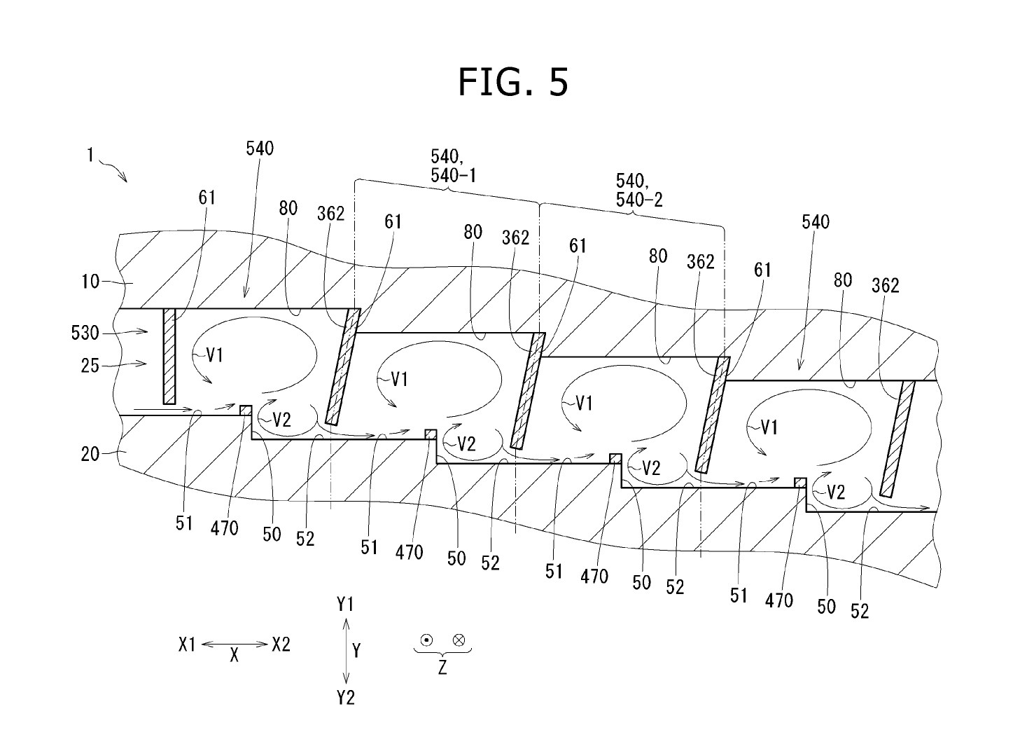

A description will now be given of a different point of a labyrinth seal structure 530 according to a fifth embodiment from the fourth embodiment (refer to FIG. 4) and the like with reference to FIG. 5. The labyrinth seal structure 530 is provided with labyrinth seals 540 arranged successively in the flow direction.

Each of the multiple labyrinth seals 540 is any one of the labyrinth seals according to the first to fourth embodiments and sixth to tenth embodiments described later. The number of the labyrinth seals 540 is two or more. For example, each of the four labyrinth seals 540 has a structure approximately the same as that of the labyrinth seal 440 according to the fourth embodiment shown in FIG. 4 in the example shown in FIG. 5.

One arranged on the high pressure side X1 out of the labyrinth seals 540 neighboring each other in the flow direction X is referred to as labyrinth seal 540-1, and one arranged on the low pressure side X2 is referred to as labyrinth seal 540-2 as shown in FIG. 5. The low-pressure-side fin 362 of the labyrinth seal 540-1 on the high pressure side X1 is used also as the high-pressure-side fin 61 of the labyrinth seal 540-2 on the low pressure side X2. The face 80 of the labyrinth seal 540-1 on the high pressure side X1 is arranged on the Y1 side with respect to the face 80 of the labyrinth seal 540 on the low pressure side X2. As a result, the portion of the first member 10 on the Y2 side is in a step shape. It should be noted that the first member 10 may not need to be in the step shape. As a result of the provision of the multiple labyrinth seals 540, multiple steps 50 are provided. As a result, the portion of the second member 20 on the Y1 side is in a step shape.

Effects of the labyrinth seal structure 530 shown in FIG. 5 are as follows.

(Eighth Effect of the Present Invention)

[Configuration 8] The labyrinth seal structure 530 has such a configuration that the labyrinth seals 540 are successively arranged in the flow direction X.

With [Configuration 8], the length of a flow passageway of the fluid can be increased in the labyrinth seal structure 530 compared with the case in which only one labyrinth seal 540 is provided. Thus, the fluid energy loss (friction loss) can be increased more. Thus, the leakage amount of the fluid is suppressed more at the labyrinth seal structure 530.

### Sixth Embodiment

A description will now be given of a different point of a labyrinth seal 640 according to a sixth embodiment mainly from the fourth embodiment (refer to FIG. 4) with reference to FIG. 6. The different point includes a shape of a low-pressure-side fin 662 and the like.

A low-pressure-side-fin side face 662a of the low-pressure-side fin 662 is in an arc shape convex to the low pressure side X2 and the Y2 side as viewed in the orthogonal direction Z. “Arc shape” may be a circular arc shape, an approximately circular arc shape, an ellipsoidal arc shape, or an approximately ellipsoidal arc shape (the same applies to other “arc shapes”). A part of the low-pressure-side-fin side face 662a may be in the arc shape or the entirety thereof may be in the arc shape as viewed in the orthogonal direction Z. The low-pressure-side fin 662 is in an arc shape convex to the low pressure side X2 and the Y2 side as viewed in the orthogonal direction Z.

It should be noted that a case in which the labyrinth seals 640 are successive in the flow direction X is shown in FIG. 6. As a result, the high-pressure-side fin 61 has the same shape (arc shape) as the low-pressure-side fin 662. On the other hand, in the case in which the labyrinth seal 640 is not successive in the flow direction X, for example, and the like, the shape of the high-pressure-side fin 61 may be different from the shape of the low-pressure-side fin 662 (the same applies to the following embodiments).

(Flow of Fluid)

A different point of the flow of the fluid according to this embodiment from the flow of the fluid according to the fourth embodiment (refer to FIG. 4) is as follows. The vortex V1 flows along the low-pressure-side-fin side face 662a. The low-pressure-side-fin side face 662a illustrated in FIG. 6 is in a shape along the flow of the vortex V1 compared with the case in which the low-pressure-side-fin side face 362a is in the straight-line shape as shown in FIG. 4 as viewed in the orthogonal direction Z. Thus, the flow amount and the flow rate of the vortex V1 can be increased. Thus, the fluid friction by the vortex V1 can be increased, and the fluid energy loss can be increased. Thus, the leakage amount of the fluid is suppressed more at the labyrinth seal 640.

### Seventh Embodiment

A description will now be given of a different point of a labyrinth seal 740 according to a seventh embodiment from the fourth embodiment (refer to FIG. 4) with reference to FIG. 7. The different point includes a shape of a face 780 of the first member 10.

The face 780 is in an arc shape (refer to the description according to the sixth embodiment for details of “arc shape”) as viewed in the orthogonal direction Z. The face 780 is in an arc shape convex to the Y1 side as viewed in the orthogonal direction Z.

(Flow of Fluid)

A different point of the flow of the fluid according to this embodiment from the flow of the fluid according to the fourth embodiment (refer to FIG. 4) is as follows. The vortex V1 flows along the face 780. The face 780 illustrated in FIG. 7 is in a shape along the flow of the vortex V1 compared with the case in which the face 80 is in the straight-line shape as shown in FIG. 4 as viewed in the orthogonal direction Z. Thus, the flow amount and the flow rate of the vortex V1 can be increased. Thus, the fluid friction by the vortex V1 can be increased, and the fluid energy loss can be increased. Thus, the leakage amount of the fluid is suppressed more at the labyrinth seal 640.

It should be noted that the face 780 may be in an arc shape convex to the Y2 side as viewed in the orthogonal direction Z.

### Eighth Embodiment

A description will now be given of a different point of a labyrinth seal 840 according to an eighth embodiment from the fourth embodiment (refer to FIG. 4) with reference to FIG. 8. The different point includes shapes of a step 850 and a protrusion 870.

The step 850 inclines with respect to the opposing direction Y so as to be arranged closer to the high pressure side X1 toward the Y1 side. The protrusion 870 includes a protrusion-high-pressure-side side face 870a and a protrusion-low-pressure-side side face 870b. The protrusion-high-pressure-side side face 870a inclines with respect to the opposing direction Y so as to be arranged closer to the low pressure side X2 toward the Y1 side. The protrusion-low-pressure-side side face 870b inclines with respect to the opposing direction Y so as to be arranged closer to the high pressure side X1 toward the Y1 side. The protrusion-low-pressure-side side face 870b is arranged so as to continue to the step 850. The protrusion-low-pressure-side side face 870b and the step 850 may continue in a straight-line shape or a curved shape as viewed in the orthogonal direction Z.

(Flow of Fluid)

A description will now be given of a different point of the flow of the fluid according to this embodiment from the flow of the fluid according to the fourth embodiment (refer to FIG. 4). The vortex V2 flows to the high pressure side X1 along the low-pressure-side landing 52, hits the step 850, and changes its direction to the Y1 side. On this occasion, the step 850 inclines with respect to the opposing direction Y so as to be arranged closer to the low pressure side X2 toward the Y1 side, and the fluid thus likely directs to the Y1 side. Thus, the flow amount and the flow rate of the vortex V2 can be increased. Thus, the fluid friction by the vortex V2 can be increased, and the fluid energy loss can be increased. Thus, the leakage amount of the fluid is suppressed more at the labyrinth seal 840.

It should be noted that if the inclination with respect to the opposing direction Y is provided on the step 850 as described before, the inclination with respect to the opposing direction Y may not be provided on at least either one of the protrusion-high-pressure-side side face 870a and the protrusion-low-pressure-side side face 870b. Moreover, the step 850 and the protrusion-low-pressure-side side face 870b may not continue to each other if the inclination with respect to the opposing direction Y is provided on the step 850 as described before.

### Ninth Embodiment

A description will now be given of a different point of a labyrinth seal 940 according to a ninth embodiment from the eighth embodiment (refer to FIG. 8) and the like with reference to FIG. 9. The different point includes a shape of a step 950.

The step 950 is in an arc shape convex to the high pressure side X1 and the Y2 side as viewed in the orthogonal direction Z. The step 950 is in such a shape as to continuously (smoothly) connect the low-pressure-side landing 52 and the protrusion-low-pressure-side side face 70b with each other. The entirety of the step 950 may be in an arc shape, or only a part of the step 950 is in an arc shape as viewed in the orthogonal direction Z. It should be noted that the protrusion 470 is configured as in the fourth embodiment (refer to FIG. 4) in the example shown in FIG. 9.

(Flow of Fluid)

A description will now be given of a different point of the flow of the fluid according to this embodiment from the flow of the fluid according to the eighth embodiment (refer to FIG. 8). The vortex V2 flows to the high pressure side X1 along the low-pressure-side landing 52, and hits the step 950. The step 950 shown in FIG. 9 is in a shape along the flow of the vortex V2 compared with the case in which the step 850 is in the straight-line shape as shown in FIG. 8 as viewed in the orthogonal direction Z. Thus, the flow amount and the flow rate of the vortex V2 can be increased. Thus, the fluid friction by the vortex V2 can be increased, and the fluid energy loss can be increased. Thus, the leakage amount of the fluid is suppressed more at the labyrinth seal 940.

It should be noted that the protrusion-low-pressure-side side face 70b may also be in an arc shape convex to the high pressure side X1 as viewed in the orthogonal direction Z as the step 950. If the step 950 and the protrusion low-pressure-side side face 70b are in a continuous arc shape as viewed in the orthogonal direction Z, the flow amount and the flow rate of the vortex V2 can be increased more.

(Comparison)

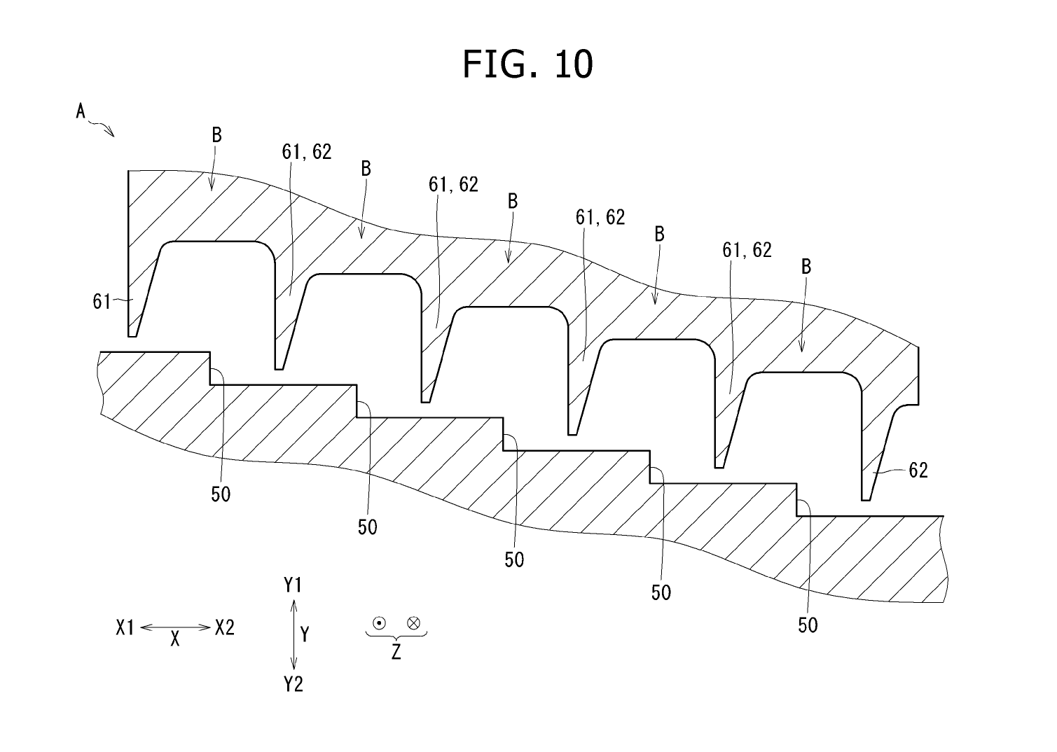

A structure A of an example 1 shown in FIG. 10 and a labyrinth seal structure 1030 of an example 2 shown in FIG. 11 are compared with each other in the leakage amount of the fluid. The structure A of the example 1 is such a structure that structures B are successively arranged in the flow direction X as shown in FIG. 10. The structure B is such a structure that the protrusion 70 is omitted from the labyrinth seal 40 according to the first embodiment shown in FIG. 1. The labyrinth seal structure 1030 of the example 2 is such a structure that labyrinth seals 1040 are successively arranged in the flow direction X as shown in FIG. 11. A main different point of the labyrinth seal 1040 shown in FIG. 10 from the labyrinth seal 440 according to the fourth embodiment shown in FIG. 4 is as follows. The high-pressure-side fin 61 closest to the high pressure side X1 inclines with respect to the opposing direction Y so as to be arranged closer to the high pressure side X1 toward the Y2 side. Thicknesses of the high-pressure-side fin 61 and the low-pressure-side fin 362 decrease toward distal end sides (Y2 side). The step 850 and the protrusion 870 are configured as the eighth embodiment (refer to FIG. 8). It should be noted that the protrusion-high-pressure-side side face 70a of the protrusion 870 (refer to FIG. 4) is configured as the fourth embodiment (refer to FIG. 4). The face 80 inclines with respect to the flow direction X so as to be arranged closer to the Y2 side toward the low pressure side X2.

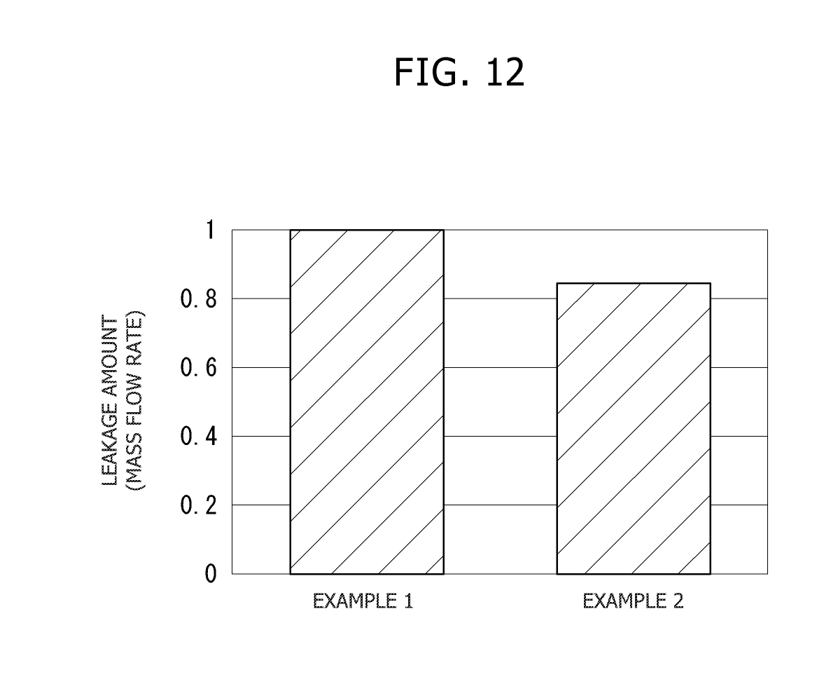

A result is shown in FIG. 12. The leakage amounts (mass flow rates) are non-dimensionalized in a chart shown in FIG. 12. Specifically, the leakage amount in the example 1 is set to 1. The leakage amount can be decreased by 15% or more in the example 2 compared with the example 1 as shown in FIG. 12.

(Relationship Between Height of Step 50 and Gap of Low-Pressure-Side Fin 62)

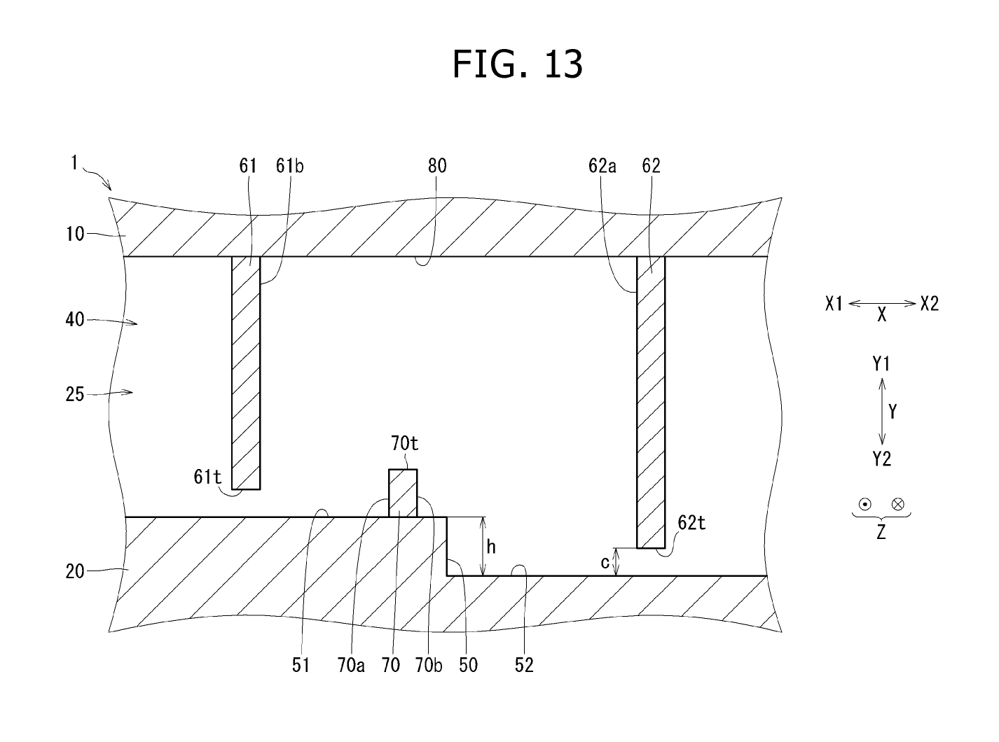

A relationship between the height (h) of the step 50 and the gap (c) of the low-pressure-side fin 62 is as follows in the labyrinth seal 40 shown in FIG. 13. It should be noted that the labyrinth seal 40 shown in FIG. 13 is a labyrinth seal 40 the same as the one shown in FIG. 1.

The height of the step 50 in the opposing direction Y is denoted by h. In more detail, h is a length in the opposing direction Y from a boundary between the step 50 and the low-pressure-side landing 52 to a boundary between the step 50 and the high-pressure-side landing 51. It should be noted that the position of the boundary between the step 50 and the high-pressure-side landing 51 may not be clear in such a case that the protrusion 270 is provided in a portion of the high-pressure-side landing 51 closest to the low pressure side X2 as shown in FIG. 2 or the like. In this case, h is a length in the opposing direction Y from a boundary between the protrusion 70 and the high-pressure-side landing 51 to a boundary between the step 50 and the low-pressure-side landing 52. Moreover, h is defined as described before in the case in which the step 850 inclines with respect to the opposing direction Y as shown in FIG. 8, in the case in which the step 950 is in the arc shape as viewed in the orthogonal direction Z as shown in FIG. 9, and the like. The size of the gap between the low-pressure-side-fin distal end 62t (the end of the low-pressure-side fin 62 on the Y2 side) and the low-pressure-side landing 52 is denoted by c as shown in FIG. 13.

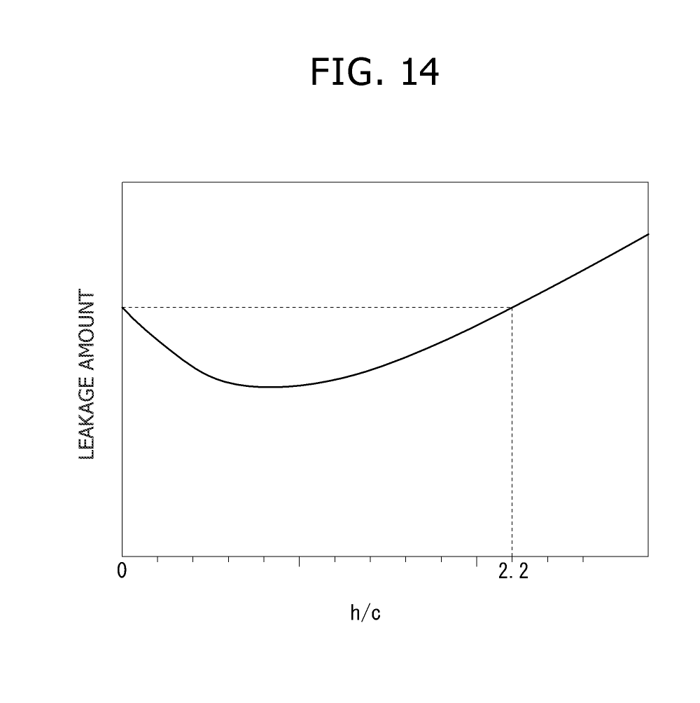

A relationship between the leakage amount of the fluid at the labyrinth seal 40 and h/c is shown in FIG. 14 where h and c are defined as described before. This result is acquired by means of the CFD (Computational Fluid Dynamics) analysis. The leakage amount of the fluid is decreased at the labyrinth seal 40 (refer to FIG. 13) in a range of 0<h/c<2.2 compared with a case in which h/c is 0, in other words, the step 50 (refer to FIG. 13) is not provided. h/c is preferably equal to or more than 0.2, is more preferably equal to or more than 0.4, is more preferably equal to or more than 0.6, and is more preferably equal to or more than 0.7. h/c is more preferably equal to or less than 2.0, is more preferably equal to or less than 1.8, is more preferably equal to or less than 1.6, is more preferably equal to or less than 1.4, is more preferably equal to or less than 1.2, is more preferably equal to or less than 1.1, and is more preferably equal to or less than 1.0. It should be noted that the leakage amount of the fluid at the labyrinth seal 40 can be decreased even if h/c is equal to or more than 2.2 compared with the case in which the protrusion 70 shown in FIG. 13 is not provided.

(Seventh Effect of the Present Invention)

[Configuration 7] The height of the step 50 in the opposing direction Y is denoted by h as shown in FIG. 14. The size of the gap between the end of the low-pressure-side fin 62 on the Y2 side (the low-pressure-side-fin distal end 62t) and the low-pressure-side landing 52 is denoted by c. On this occasion, 0<h/c<2.2.

With [Configuration 7], the flow amount of the fluid at the labyrinth seal 40 can be suppressed compared with the case in which h/c is 0 (specifically the case in which the step 50 is not provided).

(Variation)

The embodiments may be modified in various ways. For example, components from the embodiments different from one another may be combined. For example, the arrangement and the shape of each of the components may be changed. For example, the numbers of the components may be changed, and a part of the components may not be provided.

For example, the face 780 in the arc shape viewed in the orthogonal direction Z according to the seventh embodiment shown in FIG. 7 may be applied to the first to six, eighth, and ninth embodiments. For example, the low-pressure-side fin 62 extending in the direction coincident with the opposing direction Y as shown in FIG. 1 may be applied to the third, fifth, and seventh to ninth embodiments.

What is claimed is:

1. A labyrinth seal provided for a fluid machine including:
a first member;
a second member that opposes the first member; and
a gap that is formed between the first member and the second member, and is configured so that fluid flows from a high pressure side to a low pressure side of a flow direction, which is a direction orthogonal to a direction in which the first member and the second member oppose each other,
wherein the direction in which the first member and the second member oppose each other is referred to as opposing direction;
wherein a side from the second member to the first member in the opposing direction is referred to as opposing-direction first side; and
wherein a side from the first member to the second member in the opposing direction is referred to as opposing-direction second side, comprising:
a step that is formed on a portion of the second member on the opposing-direction first side;
a high-pressure-side landing that constructs a portion of the second member on the opposing-direction first side, and is arranged on the high pressure side with respect to the step;
a low-pressure-side landing that constructs a portion of the second member on the opposing-direction first side, is arranged on the low pressure side with respect to the step, and is arranged on the opposing-direction second side with respect to the high-pressure-side landing;
a high-pressure-side fin that extends from the first member toward the high-pressure-side landing, and is arranged on the high pressure side with respect to the step;
a low-pressure-side fin that extends from the first member toward the low-pressure-side landing, and is arranged on the low pressure side with respect to the step; and
a protrusion that extends from the high-pressure-side landing to the opposing-direction first side, and is arranged on the low pressure side with respect to the high-pressure-side fin,
wherein a portion connecting from a face of the high-pressure-side fin on the low pressure side to a face of the low-pressure-side fin on the high pressure side is in a straight-line shape or an arc shape as viewed in a direction orthogonal respectively to the opposing direction and the flow direction out of a face of the first member on the opposing-direction second side.

2. The labyrinth seal according to claim 1, wherein the protrusion is provided in a portion of the high-pressure-side landing closest to the low pressure side.

3. The labyrinth seal according to claim 1, wherein an end of the low-pressure-side fin on the opposing-direction second side is arranged on the high pressure side with respect to an end of the low-pressure-side fin on the opposing-direction first side.

4. The labyrinth seal according to claim 1, wherein the second member is capable of rotating about an axis of rotation extending in the flow direction with respect to the first member.

5. The labyrinth seal according to claim 4, wherein an end of the protrusion on the opposing-direction first side is arranged on the opposing-direction second side with respect to an end of the high-pressure-side fin on the opposing-direction second side.

6. The labyrinth seal according to claim 1, wherein the second member is capable of rotating about an axis of rotation extending in a direction orthogonal to the flow direction with respect to the first member.

7. The labyrinth seal according to claim 1, wherein a relationship:
0<h/c<2.2
holds true where h is a height of the step in the opposing direction, and c is a size of a gap in the opposing direction between the end of the low-pressure-side fin on the opposing-direction second side and the low-pressure-side landing.

8. A labyrinth seal structure, wherein the labyrinth seals according to claim 1 are successively arranged in the flow direction.

9. A labyrinth seal structure, wherein the labyrinth seals according to claim 2 are successively arranged in the flow direction.

10. A labyrinth seal structure, wherein the labyrinth seals according to claim 3 are successively arranged in the flow direction.

11. A labyrinth seal structure, wherein the labyrinth seals according to claim 4 are successively arranged in the flow direction.

12. A labyrinth seal structure, wherein the labyrinth seals according to claim 5 are successively arranged in the flow direction.

13. A labyrinth seal structure, wherein the labyrinth seals according to claim 6 are successively arranged in the flow direction.

14. A labyrinth seal structure, wherein the labyrinth seals according to claim 7 are successively arranged in the flow direction.
